(19) United States
(12) Patent Application Publication
(10) Pub. No.: US 2024/0382947 A1
(43) Pub. Date: Nov. 21, 2024

(54) POSITIVE DISPLACEMENT SAMPLING DEVICE, DESIGNED TO FACILITATE CAPILLARY EJECTION

(71) Applicant: GILSON SAS, VILLIERS-LE-BEL (FR)

(72) Inventors: Bruno DUDEK, ORRY-LA-VILLE (FR); Stéphane GUICHARDON, BOUGIVAL (FR); Hervé MALVOISIN, PARIS (FR)

(21) Appl. No.: 18/691,719

(22) PCT Filed: Sep. 13, 2022
(86) PCT No.: PCT/FR2022/051721

§ 371 Date: Mar. 13, 2024

(30) Foreign Application Priority Data
Sep. 14, 2021 (FR) 2109632

(51) Int. Cl. B01L 3/02

(52) U.S. Cl. CPC B01L 3/022; B01L 3/0279; B01L 2200/087

(57) ABSTRACT

An assembly for a positive displacement sampling device, the assembly comprising a tip and an ejector, the tip comprising a body, a mobile capillary retention portion connected to the body by a connector, and a lever secured to the mobile portion, such that moving this portion radially inwards, via the connector, leads to the lever moving radially outwards, the ejector being equipped with a locking member which engages with the lever such that, in the top position of the ejector, the locking member assumes a locking position in which it holds the mobile portion in an active capillary retention position by preventing the lever from moving radially outwards and, during the ejection travel, the locking member permits the lever to move radially outwards.

The present invention relates to the field of positive displacement sampling devices, for example sampling pipettes also referred to as laboratory pipettes or liquid transfer pipettes. They are intended for sampling and dispensing liquid in containers or similar. The invention also relates to positive displacement sampling devices in programmable controller form.

With regard to manual, single-channel or multi-channel pipettes, they are intended to be hand-held by an operator during liquid sampling and dispensing operations, these operations being carried out by setting a control button in motion by applying an axial pressure on said button. For so-called positive displacement pipettes, they are intended to cooperate with plunger-capillary system type consumables, the piston of which is provided to be directly in contact with the specimen to be sampled, before being ejected or reused. Positive displacement pipettes therefore have a different design from those of more conventional air displacement pipettes, wherein the piston is an integral part of the pipette and is not in direct contact with the specimen.

In a known manner, the capillary is intended to be fitted on a tip of the pipette. The holding force of the capillary on the tip must be sufficiently substantial to ensure that the capillary is not detached during pipetting operations, in particular during dispensing, regardless of the viscosity of the liquid.

These requirements require a firm axial fit of the capillary on the tip of the pipette, resulting in increasing difficulty ejecting the capillary as the fitting force increases.

This ambivalent situation poses a problem in terms of plunger-capillary system ejection ergonomics. Indeed, the operator may be required to develop a substantial force to produce the sought ejection using the ejector integrated in the pipette. This may then result in comfort problems, as well as the onset of repetitive strain injury (RSI).

Similar problems are encountered on devices, such as programmable controllers, performing motorised ejection of the plunger-capillary system, because the ejection motor must be sized sufficiently to counter the fitting force of the capillary on the tip, in order to break the mechanical connection between the two. It is noted that these problems are exacerbated on a multi-channel design.

To address this issue, the invention relates to a positive displacement device assembly, the assembly comprising:
a tip intended to support a capillary of a plunger-capillary system, the tip being hollow, centred on a longitudinal central axis of the tip, and including an outer surface provided with an axial retention member of the capillary,
an ejector intended to eject the plunger-capillary system, the assembly being designed so as to enable an axial ejection travel of the ejector relative to the tip, between a top resting end position and a bottom ejection end position, the ejector comprising an ejection end intended to be in axial contact with a capillary end during the ejection travel.

According to the invention, the tip includes a body as well as a movable capillary retention portion connected to the body by a link, the movable retention portion including on its outer surface at least a part of said axial retention member of the capillary,
the tip also including a lever rigidly connected to the movable retention part, such that a tilting of the movable part radially inwards, via the link and relative to the tip body, actuates a tilting of the lever radially outwards,
the ejector being equipped with a locking member cooperating with the lever such that:
   in the top resting end position of the ejector, the locking member occupies a locking position wherein it holds the movable portion of the tip in an active holding position of the capillary, by preventing the lever from tilting radially outwards; and
   during the ejection travel of the ejector, the locking member:
   allows the tilting of the lever radially outwards, resulting from a tilting of the movable portion radially inwards from its active holding position of the capillary, to a retracted release position of the capillary, or
   actuates the tilting of the lever radially outwards, resulting in a tilting of the movable portion radially inwards from its active holding position of the capillary, to its retracted release position of the capillary.

The invention thus provides for functionalising the tip, by having it adopt a segmented/slotted design which allows it to address the ambivalent situation described above in a satisfactory manner. Indeed, thanks to the invention, the movable retention portion borne on the tip can be held in its active holding position of the capillary during pipetting operations, thus ensuring a firm fit of this capillary on the tip. Furthermore, the ability of said movable retention portion to retract, into its retracted release position of the capillary, makes it possible to substantially limit the force to be deployed on the ejector to trigger the detachment and ejection of the plunger-capillary system.

It is finally highlighted that the invention also makes it possible to offset the ejection function onto a secondary system, whereas in existing systems, the ejection control is generally accumulated with the pipetting control, and substantial forces hence result.

The invention preferably has at least one of the following optional features, taken alone or in combination.

Preferably, in the tip, the link between the movable capillary retention portion and the tip body is a flexible, elastically deformable link.

Preferably, the tip includes an intermediate ring centred on its longitudinal central axis, and the flexible link is produced by two flexible zones of reduced thickness, between which a first angular ring sector as well as a second angular ring sector are delimited, the first angular sector being rigidly connected to the movable capillary retention portion and the lever while being arranged between the two, whereas the second angular sector is rigidly connected to the tip body.

Preferably, the two flexible zones of reduced thickness are diametrically opposed.

Preferably, the tip also includes a fastening plate, rigidly connected to the second angular ring sector.

Preferably, the tip is made of one piece, even if alternatively, a design in several parts assembled with each other may be envisaged, without leaving the scope of the invention.

Preferably, the locking member provided on the ejector is embodied by a radial stop member, intended to cooperate with an inclined plane of the tip lever.

According to an alternative to the flexible link described above, the link between the movable capillary retention portion and the tip body can be a pivot link or a ball joint link. Preferably, the movable capillary retention portion has a general half-cylinder shape. Preferably, another part of said axial retention member of the capillary is provided on the outer surface of the tip body.

In this regard, it is noted that the axial retention member of the capillary is preferably embodied using at least one annular bead on the outer surface of the tip.

Preferably, the movable capillary retention portion and the tip lever are made of one piece, regardless of the design selected for the link between the movable retention portion and the tip body.

The invention also relates to a positive displacement device comprising at least one such assembly. For example, this device is a single-channel or multi-channel, manual or motorised, positive displacement sampling pipette, or a single-channel or multi-channel positive displacement sampling programmable controller.

Further advantages and features of the invention will become apparent in the non-restrictive detailed description hereinafter.

The description will be given with regard to the appended drawings wherein;

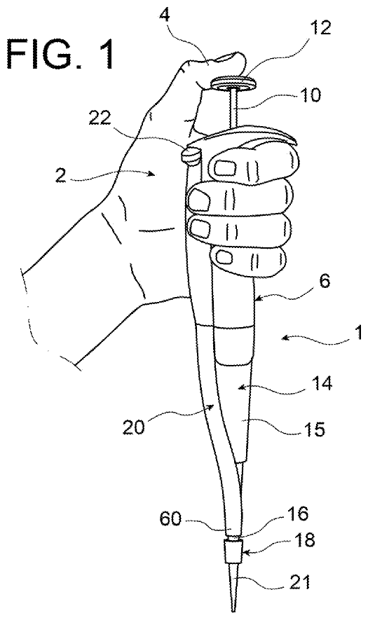

FIG. 1 represents a perspective view of a positive displacement sampling pipette, according to the invention;

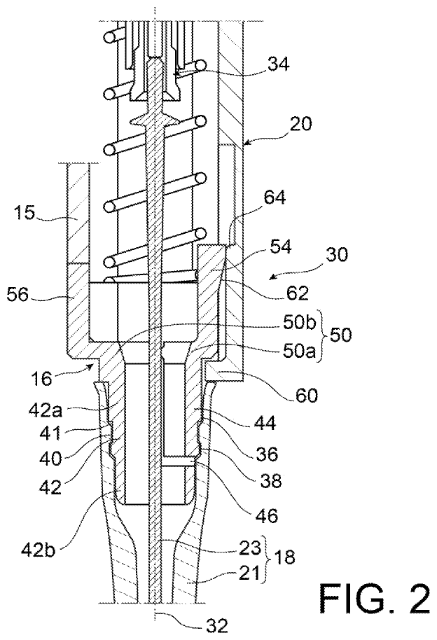

FIG. 2 represents a partial longitudinal sectional view of the pipette shown in the preceding figure, showing in particular an assembly according to a first preferred embodiment of the invention;

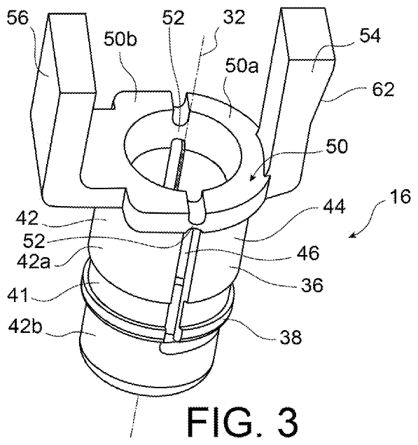

FIG. 3 represents a perspective view of the pipette tip belonging to the assembly shown in the preceding figure;

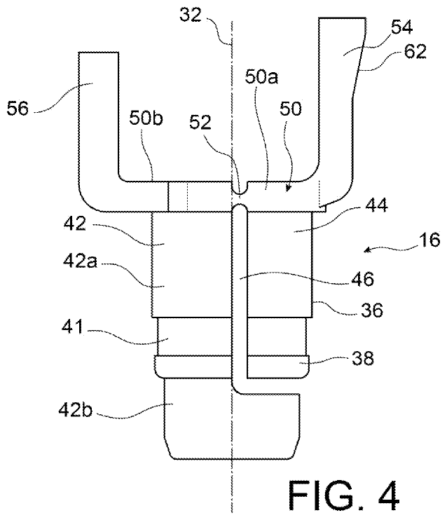

FIG. 4 represents a side view of the tip shown in the preceding figure;

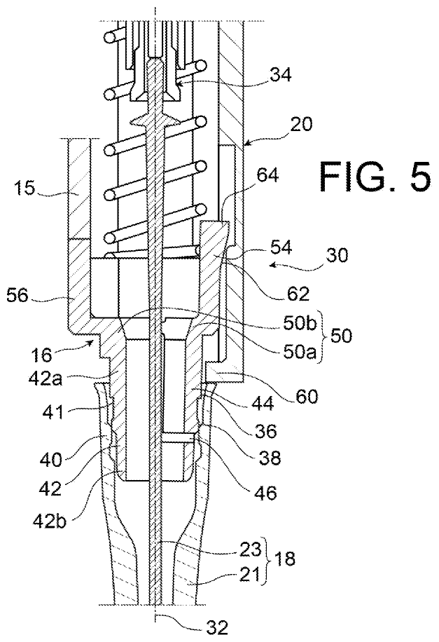

FIG. 5 represents a partial longitudinal sectional view similar to that of FIG. 2, showing the assembly at a given time during a plunger-capillary system ejection operation;

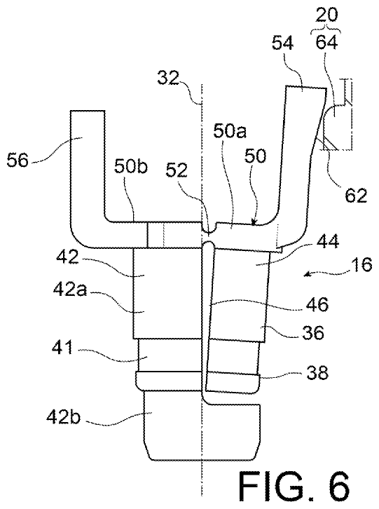

FIG. 6 represents a perspective view of the tip, in its state as adopted at the given time represented in FIG. 5;

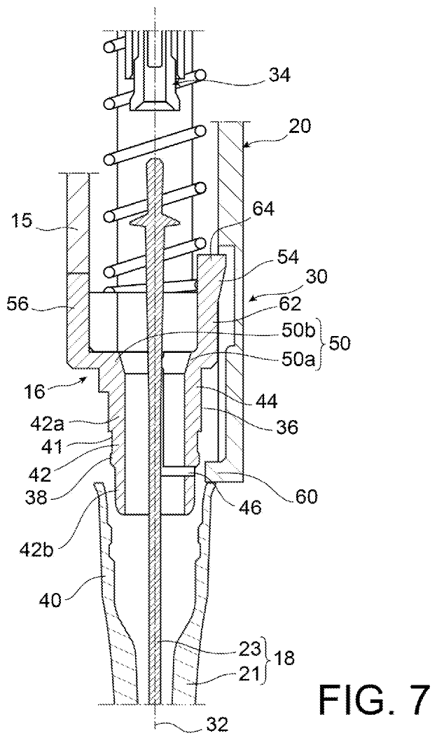

FIG. 7 represents a partial longitudinal sectional view similar to that of FIG. 5, at the end of the plunger-capillary system ejection operation; and

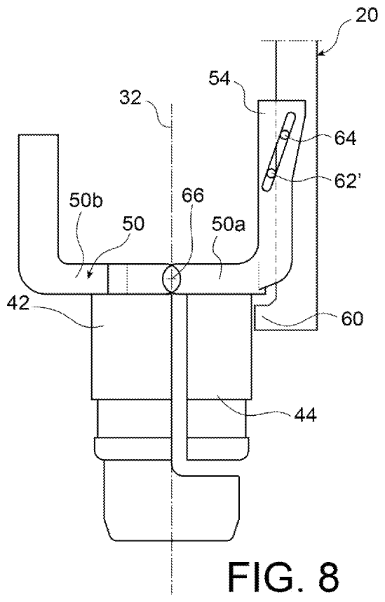

FIG. 8 represents a side view of the assembly, according to a second embodiment of the invention.

With reference first of all to FIG. 1, a manually actuated single-channel positive displacement pipette 1, according to the present invention, is represented. This manual pipette is also referred to as “mechanical pipette”. Throughout the following description, the terms “top” and “bottom” are to be considered with the pipette held upright, in the pipetting position or close to said position.

In FIG. 1, the pipette 1 is represented held in the hand 2 of an operator, who, using their thumb 4, actuates the pipette to give rise to the dispensing of a previously aspirated liquid. More specifically, the pipette 1 comprises a handle 6 forming the upper body of the pipette, from which handle a pipetting control rod 10 emerges. The latter supports at its top end, in the pipetting position, a control button 12 of which the upper part is intended to be pressed by the operator's thumb 4.

As an indication, it is noted that a display screen (not shown) may be provided on the handle 6. Similarly, means for setting the volume to be sampled are also accessible to the operator on this handle 6.

Under the handle 6, the pipette 1 includes a removable bottom part 14, of which an outer bottom part body 15. The bottom part 15 ends at the bottom with a tip 16 receiving a consumable 18, referred to as plunger-capillary system. In FIG. 1, only the capillary 21 of the system 18 can be seen, because the plunger is located inside the capillary 21 and the tip 16. In a known manner, after pipetting, the plunger-capillary system 18 can be ejected mechanically by an ejector 20 of which the actuation button 22 is located for example projecting over the top of the handle, in the vicinity of the control button 12.

The pipetting control rod 10 is connected at its bottom end to a grip system (not seen in FIG. 1), capable of gripping and then releasing the plunger of the plunger-capillary system 18, according to a known manner which will not be described here.

With reference now to FIGS. 2 to 4, an assembly 30 according to a first preferred embodiment of the invention is represented, this assembly being integrated in the pipette shown in FIG. 1, and including overall the tip 16 and the ejector 20 of specific designs. The tip 16, most visible in FIGS. 3 and 4, has a hollow shape while being centred on a longitudinal central axis 32 of the tip, corresponding here to the longitudinal central axis of the single-channel pipette. The hollow of the tip 16 is intended to be passed through by the plunger 23 of the plunger-capillary system 18, of which the top end is gripped by the grip system 34 actuated by the pipetting control rod.

The outer surface 36 of the tip 16 is provided with an axial retention member 38 of the capillary, embodied by an annular bead centred on the axis 32, or in shoulder form or any similar form. In any case, the member 38 forms an axial stop intended to hold the capillary 21 on the tip 16. In a known manner, the inner surface of the upper part of the capillary is shaped to cooperate with the axial retention member 38 of the tip, for example by disposing an annular protrusion 40 extending radially inwards, housed in a recess 41 of the tip delimited at the bottom by the member 38.

More specifically, the axial retention member 38 of the capillary does not extend continuously all around the outer surface 36 of the tip, because the latter has a segmented/slotted design specific to the invention, and which will be described hereinafter. The member 38 hence has the same segmented/slotted design in the circumferential direction.

The main part of the tip 16 is indeed not completely cylindrical, because a segmentation is carried out between a tip body 42 and a movable capillary retention portion 44. The tip body 42 is fixed, its top part 42a having a general half-cylinder shape, whereas its bottom part 42b adopts a general whole cylinder shape, the two parts being arranged axially in line with each other and preferably made from a single piece, i.e. one-piece or unsegmented. The material used is preferably a plastic, or for example overmoulded aluminium.

The hollowed part of the tip body 42, facing its top part 42a, is occupied by the movable retention portion 44, also preferably in a general half-cylinder shape. Together, the tip body 42 and the movable retention portion 44 form a conventional tip, except that a space 46 separates them circumferentially and axially, resulting in the segmented/slotted design cited above.

The bead or the shoulder 38 is located in part on the outer surface of the tip body 42, and in part on the outer surface of the movable retention portion 44.

The two elements 42, 44, which therefore together form a large part of a cylinder centred on the axis 32, are connected to each other at their top end using an intermediate ring 50, also centred on the axis 32.

This ring 50 incorporates a flexible link between the tip body 42 and the movable retention portion 44, in the form of two flexible zones 52 of reduced thickness, and diametrically opposed. Between these two flexible zones 52, a first angular ring sector 50a rigidly connected to the movable retention portion 44 is first defined, and, opposite, a second angular ring sector 50b rigidly connected to the tip body 42. The flexible link allows overall, by elastic deformation of the two flexible zones 52, a pivoting movement of the two angular ring sectors 50a, 50b in relation to each other, along a transversal pivoting axis passing through these two flexible zones 52.

Here again, the intermediate ring 50 is preferably made of one piece with the elements 42, 44 of the tip.

In line with the top of the movable retention portion 44, from the first angular ring sector 50a, the tip is completed by a lever 54. The first angular ring sector 50a is thus arranged between the movable portion 44 and the lever 54, along the direction of the axis 32. The elements 44, 50a and 54 thus form a rigidly connected assembly, preferably made of one piece, and intended to undergo little deformation when the pipette is used. On the other hand, to carry out the operation which will be described hereinafter, a certain rigidity is sought in such a way that this assembly can move without being deformed, and in particular to ensure that a tilting of the movable retention part 44 radially inwards, via the link 52, 52 and relative to the tip body 42, actuates a tilting of the lever 54 radially outwards.

Finally, the tip 16 is completed by a fastening plate 56 extending upwards from the second angular ring sector 50b. The plate 56, arranged diametrically opposite the lever 54, forms a fixed part of the tip which is intended to be fastened directly or indirectly on the outer body 15 of the bottom pipette part.

The ejector 20, seen in FIG. 2, is for its part intended to eject the plunger-capillary system 18 by axial pressure on the top end of the capillary 21. The pipette allows an axial ejection travel of the ejector 20 relative to the tip 16, between a top resting end position shown in FIG. 2, and a bottom ejection end position shown in FIG. 7 which will be described hereinafter. To do this, the ejector 20 comprises a bottom ejection end 60 intended to be in axial contact with a top capillary end, during the ejection travel. In a known manner, the bottom ejection end 60 of the ejector, centred on the axis 32, can have a high circumferential range, exceeding for example 180°.

The ejector 20 and the lever 54 are intended to cooperate together to hold a firm fit of the capillary 21 on the tip 16 during pipetting, while making it possible to limit the force to be deployed on the ejector 20 to trigger the ejection of the plunger-capillary system 18.

Thus, the lever 54 has at the top end a radially outer cam surface 62, of which the shape is such that this surface 62 moves radially away from the axis 32 upwards. The cam surface 62 can therefore be an inclined plane, or alternatively a curved surface.

Moreover, to cooperate with the cam surface 62 of the lever 54, the ejector 20 is equipped with a locking member 64 which corresponds here to an axial stop member. In the top resting end position of the ejector 20, as shown in FIG. 2, the locking member 64 occupies a locking position wherein it is located in contact with the cam surface 62, while being arranged radially outwards relative thereto. Hence, the locking member 64 prevents the lever 54 from tilting radially outwards, and holds the latter in a straight position, thus helping keep the movable retention portion 44 in an active holding position of the capillary. The active holding position of the movable portion 44, as shown in FIG. 2, also corresponds to a straight position of this movable retention portion 44, wherein it reconstitutes at best the cylinder with the fixed tip body 42. In other words, in this active holding position, the part of the bead 38 located on the outer surface of the movable retention portion 44 is arranged in its most eccentric position relative to the axis 32, which allows it to help hold the capillary 21 firmly on the tip. Locking the movable retention portion 44 in this position, by radial pressure between the elements 62, 64 thus allows pipetting operations without any risk of breaking the link between the tip and the capillary. After pipetting, when the ejection travel is initiated, the ejector 20 is moved downwards and rapidly comes into contact with the top end of the capillary 21, which will be detached from the tip 16. In this regard, it is noted that at this stage, the plunger 23 has been released from the grip system in a known manner, which will not be described here.

While the bottom ejection end 60 of the ejector 20 presses on the top end of the capillary 21, the ejector in its downward movement actuates with it the locking member 64, in the form of a boss, slug, or any other relief shape capable of forming the sought radial stop.

A downward movement of the locking member 64 along the cam surface 62 then occurs, allowing the tilting of the lever 54 radially outwards on account of its inclined plane shape. The tilting of the lever 54 results from a tilting of the movable portion 44 radially outwards, itself produced by the pressure of the capillary 21 on the part of the bead 38 at the surface of the movable portion 44. Such a scenario, allowed by the elastic deformation of the flexible link 52, 52 and by the unlocking of the lever 54, is represented in FIGS. 5 and 6 showing the assembly at an intermediate stage during the ejection travel, at which stage the movable member 44, constrained radially inwards, adopts a retracted release position of the capillary 21.

FIG. 7 represents for its part the scenario at the end of the ejection travel, when the bottom ejection end 60 of the ejector, in the bottom ejection end position, has moved the capillary 21 sufficiently away so that the latter no longer has contact with the outer surface 36 of the tip 16. At this stage, the movable retention portion 44 has returned to its straight position on account of the fact that it is no longer constrained by the capillary 21, and under the effect of the elastic return force produced by the flexible zones 52 of the link. When the ejector 20 is released by the operator and returns under the effect of a spring to its top resting end position, the locking member 64 restores contact with the inclined lever cam surface 62, resulting in the locking thereof as in FIG. 2.

As an indication, it is noted that the initial operation of positioning the capillary 21 on the tip 16 is performed in a classic and conventional manner, with force, by moving the pipette vertically downwards. The capillary 21 is then gripped thanks to a slight elastic deformation of the movable holding portion 44, until the desired cooperation between the bead 38 of the tip and the protrusion 40 of the capillary. During this gripping operation of the capillary 21, the lever 54 remains immobile in its locked position.

FIG. 8 represents a second preferred embodiment of the invention, wherein the flexible zones 52 are replaced by a pivot or ball joint link 66, taking here the form of two half-links providing the junction between the two intermediate ring sectors 50a, 50b. The pivot link 66, of an axis passing through the two half-links, is produced conventionally, for example using a shaft, a clevis, etc. The link 66 can be equipped with elastic return means forcing the movable retention portion 44 towards its active holding position of the capillary. Alternatively, the position of the movable retention portion 44 may be dictated by the relative position of the locking member 64 of the ejector in an inclined groove 62′ formed on the lever 54.

During the ejection travel, the locking member 64 in slug or roll form, on moving in the groove 62′, actuates the tilting of the lever 54 radially outwards, then leading to a tilting of the movable portion 44 radially inwards from its active holding position of the capillary 21, towards its retracted release position of the capillary.

Obviously, various modifications may be made by a person skilled in the art to the invention described above, merely by way of non-restrictive examples, and the scope of which is defined by the appended claims. In particular, the preferred embodiments described above correspond to the implementation of the invention on a manual or single-channel pipette, but all the teachings may be transposed to other types of pipettes, motorised and/or multi-channel, or to programmable controllers.

What is claimed is:

1. A positive displacement device assembly, the assembly comprising:
a tip intended to support a capillary of a plunger-capillary system, the tip being hollow, centred on a longitudinal central axis of the tip, and including an outer surface provided with an axial retention member of the capillary,
an ejector intended to eject the plunger-capillary system, the assembly being designed so as to enable an axial ejection travel of the ejector relative to the tip, between a top resting end position and a bottom ejection end position, the ejector comprising an ejection end intended to be in axial contact with a capillary end during the ejection travel, wherein
the tip includes a body as well as a movable capillary retention portion connected to the body by a link, the movable retention portion including on its outer surface at least a part of said axial retention member of the capillary,
the tip also including a lever rigidly connected to the movable retention part, such that a tilting of the movable part radially inwards, via the link and relative to the tip body, actuates a tilting of the lever radially outwards,
the ejector being equipped with a locking member cooperating with the lever such that:
in the top resting end position of the ejector, the locking member occupies a locking position wherein it holds the movable portion of the tip in an active holding position of the capillary, by preventing the lever from tilting radially outwards; and
during the ejection travel of the ejector, the locking member either:
allows the tilting of the lever radially outwards, resulting from a tilting of the movable portion radially inwards from its active holding position of the capillary, to a retracted release position of the capillary, or
actuates the tilting of the lever radially outwards, resulting in a tilting of the movable portion radially inwards from its active holding position of the capillary, to its retracted release position of the capillary.

2. The assembly according to claim 1, wherein, in the tip, the link between the movable retention portion of the capillary and the tip body is a flexible, elastically deformable link.

3. The assembly according to claim 2, wherein the tip includes an intermediate ring centred on its longitudinal central axis, and wherein the flexible link is produced by two flexible zones of reduced thickness, between which a first angular ring sector as well as a second angular ring sector are delimited, the first angular sector being rigidly connected to the movable retention portion of the capillary and the lever while being arranged between the two, whereas the second angular sector is rigidly connected to the tip body.

4. The assembly according to claim 3, wherein the two flexible zones of reduced thickness are diametrically opposed.

5. The assembly according to claim 3, wherein the tip also includes a fastening plate, rigidly connected to the second angular ring sector.

6. The assembly according to claim 2, wherein the tip is made of one piece.

7. The assembly according to claim 2, wherein the locking member provided on the ejector is embodied by a radial stop member, intended to cooperate with an inclined plane of the tip lever.

8. The assembly according to claim 1, wherein, in the tip, the link between the movable capillary retention portion and the tip body is a pivot link or a ball joint link.

9. The assembly according to claim 1, wherein the movable capillary retention portion has a general half-cylinder shape.

10. The assembly according to claim 1, wherein another part of said axial retention member of the capillary is provided on the outer surface of the tip body.

11. The assembly according to claim 1, wherein the axial retention member of the capillary is embodied using at least one annular bead on the outer surface of the tip.

12. The assembly according to claim 1, wherein the movable capillary retention portion and the tip lever are made of one piece.

13. A positive displacement sampling device comprising at least one assembly according to claim 1.

14. The device according to claim 13, wherein the device is a single-channel or multi-channel, manual or motorised, positive displacement sampling pipette.

15. The device according to claim 13, wherein the device is a single-channel or multi-channel, manual or motorised, positive displacement sampling programmable controller.
